(19) United States
(12) Patent Application Publication
(10) Pub. No.: US 2011/0210141 A1
(43) Pub. Date: Sep. 1, 2011

(54) Method and device for dosed dispensing of a liquid from a container ("Draught Flair")

(75) Inventors: Wilhelmus Johannes Joseph Maas, Someren (NL); Petrus Lambertus Wilhelmus Hurkmans, Someren (NL)

(73) Assignee: Dispensing Technologies B.V., DN Helmond (NL)

(21) Appl. No.: 12/931,280

(22) Filed: Jan. 28, 2011

(30) Foreign Application Priority Data
Jul. 28, 2008 (NL) NL1035761
Jul. 28, 2009 (NL) PCT/NL2009/050462

(51) Int. Cl. B67D 7/06

(52) U.S. Cl. 222/1; 222/394; 222/148; 222/635

(57) ABSTRACT

Methods and systems for the dosed dispensing of a liquid from a container connected to an outflow channel closable by a liquid valve are presented. Such methods include opening the liquid valve, dispensing a measure of liquid from the container through the outflow channel, closing the liquid valve, and blowing out the outflow channel after closing the liquid valve. For example, during or after closing of the liquid valve the outflow channel can be connected to a gaseous source, the gas at a pressure greater than atmospheric pressure. Or, for example, where Flair™ technology is used, a limited quantity of a displacing gas can be guided to the outflow channel during or after closing of the liquid valve, or can be guided into an intermediate chamber connected to the outflow channel during or after closing of the liquid valve.

### CROSS REFERENCE TO RELATED APPLICATIONS

This is a continuation-in-part application of PCT/NL2009/050462, which is hereby incorporated herein by reference. PCT/NL2009/050462 was published as WO 2010/014004 A2, on 4 Feb. 2010. PCT/NL2009/050462 claims priority to NL 1035761, filed on 28 Jul. 2008, which is also hereby incorporated herein by reference. Applicants hereby claim priority under 35 U.S.C. §119 to both (i) PCT/NL2009/050462 and to (ii) NL 1035761 (filed in The Netherlands).

### TECHNICAL FIELD

The present invention relates to dosed dispensing of liquids and the like, and in particular to opening a valve to dispense the liquid, and after closing the valve, blowing out the outflow channel of the container.

### BACKGROUND OF THE INVENTION

The present invention relates to the dosed dispensing of a liquid from a container which is connected to an outflow channel closable by a liquid valve, by opening the liquid valve, dispensing a measure of liquid from the container through the outflow channel and closing the liquid valve. Such methods are generally known and are for instance applied when beer is tapped from a container. However, the known methods has a number of drawbacks. The outflow channel will for instance generally have a curved or bent form, and after closing of the liquid valve a small quantity of liquid usually remains in those parts of the outflow channel which run substantially horizontally. This liquid will then often drip out of the outflow channel later, this resulting in contamination in the vicinity of the container. This is particularly inconvenient in the case of so-called home-tap systems, wherein the container stands on a kitchen worktop or lies in a refrigerator. In addition, the liquid left behind in the outflow channel may eventually spoil, whereby fungal or bacterial growth can occur in the outflow channel, this causing a public health hazard.

In addition, the liquid valve must be urged back with force to its closed position in order to prevent leakage. One or more resetting springs are often provided for this purpose. These must be manufactured from a high-grade material in order to be able to withstand contact with the liquid. Such resetting springs are moreover often difficult to install. The costs of the dispensing system hereby increase, this being a disadvantage particularly in the case of home tap-systems which are discarded after use.

Finally it is not always easy to connect the outflow channel in a reliable and leak-free manner to the container, particularly when the contents of the container are under pressure, as can be the case with various home-tap systems for beer or other beverages, such as, for example, carbonated beverages.

What is thus needed in the art are systems and methods for performing such dosed dispensing of liquids, where the above-identified drawbacks do not occur, or at least are ameliorated.

### BRIEF DESCRIPTION OF THE DRAWINGS

In what follows, the present invention is described via a number of examples, described with reference to the accompanying drawings, in which:

FIG. 1A shows a section through the upper part of a container having connected thereto a dispensing device according to a first embodiment of the invention in a position in which the device is ready to dispense liquid from the container;

FIG. 1B shows a sectional detail view on enlarged scale of a part of the outflow channel and the liquid valve in the position of FIG. 1A;

FIGS. 2A and 2B are views corresponding to FIGS. 1A and 1B of the container and dispensing device at the start of the dispensing, just before the liquid valve is opened;

FIGS. 3A and 3B are views corresponding to FIGS. 1A and 1B of the container and dispensing device during dispensing of liquid from the container, wherein the liquid valve is opened but the gas valve is closed;

FIGS. 4A and 4B are views corresponding to FIGS. 1A and 1B of the container and dispensing device during blowout of the outflow channel after dispensing of liquid, wherein the liquid valve is closed and the gas valve is opened;

FIG. 5 shows a detail view corresponding to FIG. 1B of a second embodiment of the invention in the ready-to-use position;

FIGS. 6, 7 and 8 show views corresponding to FIG. 5 of this embodiment, respectively prior to dispensing, during dispensing and during blow-out;

FIG. 9 is a perspective view of the second embodiment of the dispensing device, FIG. 10 is a longitudinal section through the device of FIG. 9;

FIG. 11 is a perspective view from another angle of the dispensing device of FIG. 9 before it is connected to the container;

FIGS. 12 and 13 are views corresponding to FIGS. 5 to 8 which show how the dispensing device is connected to the container;

FIG. 14 is a section which shows the top part of the container and the dispensing device in a transport and storage position in which the liquid valve is blocked;

FIG. 15 is an exploded perspective view of a dispensing device in accordance with a third, currently preferred embodiment of the invention, FIG. 16 is a sectional perspective view of the dispensing device of FIG. 15;

FIG. 17 shows a view corresponding to FIG. 1A, illustrating the third embodiment of the invention in the ready-to-use position;

FIGS. 18, 19 and 20 show views corresponding to FIG. 17, respectively prior to dispensing, during dispensing and during blow-out;

FIG. 21 depicts an exploded view of various components of a second generation non-dripping nozzle according to an exemplary embodiment of the present invention;

FIG. 22 depicts exemplary assembly of the second generation non-dripping nozzle according to an exemplary embodiment of the present invention;

FIG. 23 depicts various views of an assembled non-dripping nozzle according to an exemplary embodiment of the present invention;

FIG. 24 depicts an exemplary non-dripping nozzle on and off an exemplary bottle according to an exemplary embodiment of the present invention;

FIG. 25 depicts various cross-sectional views of an assembled non-dripping nozzle as attached to an exemplary container according to an exemplary embodiment of the present invention;

FIGS. 26-29 depict various steps in dispensing a liquid according to exemplary embodiment of the present invention;

FIG. 30 depicts a comparison of blowout air volume in a first generation and a second generation device according to exemplary embodiments of the present invention;

FIG. 31 depicts a cross sectional structural comparison of such first and second generation devices;

FIGS. 32-33 respectively depict a front view and a perspective cross-sectional view of the exemplary first-generation device of FIGS. 30-31 (left panes);

FIG. 34 depicts a longitudinal cross-sectional view of the exemplary first-generation device of FIGS. 32-33;

FIG. 35 depicts a front view of the exemplary second generation device of FIGS. 30-31 (right pane); and

FIGS. 36-44 respectively depict various views and other details of the exemplary second generation device of FIGS. 30-31 (right pane).

It is noted that the patent or application file contains at least one drawing executed in color. Copies of this patent or patent application publication with color drawing(s) will be provided by the U.S. Patent and Trademark Office upon request and payment of the necessary fee.

### SUMMARY OF THE INVENTION

Methods and systems for the dosed dispensing of a liquid from a container connected to an outflow channel closable by a liquid valve are presented. Such methods include opening the liquid valve, dispensing a measure of liquid from the container through the outflow channel, closing the liquid valve, and blowing out the outflow channel after closing the liquid valve. For example, during or after closing of the liquid valve the outflow channel can be connected to a gaseous source, the gas at a pressure greater than atmospheric pressure. Or, for example, where Flair™ technology is used, a limited quantity of a displacing gas can be guided to the outflow channel during or after closing of the liquid valve, or can be guided into an intermediate chamber connected to the outflow channel during or after closing of the liquid valve.

### DETAILED DESCRIPTION OF THE INVENTION

According to a first aspect of the invention, an exemplary method includes blowing out the outflow channel of a dispensing device after closing the liquid valve. In this way liquid is prevented from remaining in the outflow channel and possibly dripping after use or spoiling. By “blowing out” it is meant that a gas, e.g. air is forced through the outflow channel.

Blow-out of the outflow channel can be effected in a simple and reliable manner by connecting the outflow channel, during or after closing of the liquid valve, to a source of gas under a higher than atmospheric pressure. This gas can then, for example, escape through the outflow channel to the environment and thereby carry with it any liquid residue.

In systems where, for example, liquid is forced out of the container during dispensing by a displacing gas that is at a pressure higher than atmospheric pressure, a limited quantity of such displacing gas can, for example, be guided to the outflow channel during or after closing of the liquid valve. The same gas used to dispense the liquid from the container can thus also be used to blow out the outflow channel.

In order to prevent too much displacing gas escaping from the container during blow-out of the outflow channel, the amount of displacing gas, can be, for example, guided, during dispensing of the liquid, into an intermediate chamber which is connected to the outflow channel during or after closing of the liquid valve.

In a second aspect of the invention, an exemplary method can include after closing of a liquid valve that the outflow channel is aerated from an opening located substantially immediately downstream of the liquid valve. By introducing air or another gas through an opening immediately downstream of the liquid valve, i.e. at the very beginning of the outflow channel, complete cleaning of the channel is insured. This effect can be achieved regardless of the pressure of the air (or other gas) that is introduced through the aerating opening.

In a third aspect of the invention, an exemplary method can include that at least during dispensing of the liquid a higher than atmospheric pressure prevails in the container and the liquid valve can be biased to its closed position by such higher than atmospheric pressure in the container. By making use of the pressure in the container to move the valve to its closed position, it is possible to dispense with the use of resetting springs, or to use smaller, simpler or fewer resetting springs. The liquid valve can thus be biased to its closed position in simple manner by the liquid in the container.

When use is made of a displacing gas in the container for the purpose of dispensing the liquid, such as in the liquid valve can also be biased to its closed position by this displacing gas.

Exemplary embodiments of the present invention further relate to a device with which the above described methods can be applied. Known devices for dosed dispensing of liquid from a container generally comprise an outflow channel which can be connected to the container and which can be closed by a liquid valve.

According to a first aspect of the invention, an improved dispensing device can be provided with structures for blowing out the outflow channel when the liquid valve is closed. These blow-out structures can be adapted to connect the outflow channel, when the liquid valve is closed, to a source of a gas under higher than atmospheric pressure.

When the container contains a displacing gas under higher than atmospheric pressure for the purpose of pushing the liquid out of the container, such as, for example, in the various embodiments of “bag within a bag” Flair™ Technology provided by Dispensing Technologies, B.V. of Helmond, the Netherlands, the blow-out structures can advantageously be adapted to guide a limited amount of the displacing gas to the outflow channel when the liquid valve is closed. A structurally simple and qualitatively high-grade dispensing device can be obtained when the container is assembled from a form-retaining outer container and a deformable inner container in which the liquid is received, where the displacing gas is provided in a space defined between the outer container and the inner container. In such systems, as is known, the displacing gas does not come into contact with the liquid.

In such Flair™ type systems, blow-out structures can include an intermediate chamber which is (i) connected to the space between the inner and outer container when the liquid valve is opened, and which is (ii) connected to the outflow channel when the liquid valve is closed.

In exemplary embodiments of the present invention, when the intermediate chamber is closable by a gas valve movable with the liquid valve, blow-out can be synchronized with closing of the liquid valve in structurally simple manner.

In a second aspect of the invention, a dispensing device can, for example, have an opening formed in the outflow channel substantially immediately downstream of the liquid valve for aerating the outflow channel when the liquid valve is closed.

In a third aspect of the invention, a dispensing device can have the feature that at least during dispensing of the liquid, a higher than atmospheric pressure prevails in the container and this higher than atmospheric pressure in the container can, for example, be used to bias the liquid valve to its closed position. In such exemplary embodiments, the liquid valve can be biased to its closed position by, for example, the liquid in the container and/or by, for example, a displacing gas in the container.

In exemplary embodiments of the present invention the gas valve can also be biased to its closed position by the displacing gas, thus obviating any need for mechanical springs.

In a fourth aspect of the invention, an dispensing device can have a connector for connecting the outflow channel to the container, which connector can include at least one resilient ring to be arranged around an outflow opening of the container and at least one locking ring to be arranged around the resilient ring. The outflow channel with the liquid valve connected thereto can thus be connected in simple and reliable manner to the container, where the thusly formed connection can be well able to withstand a higher than atmospheric pressure that may prevail in the container.

In exemplary embodiments of the present invention the resilient ring can comprise a substantially non-deformable base ring and a number of resiliently deformable hooking fingers protruding radially outward from the base ring. In exemplary embodiments of the present invention the locking ring can slide close-fittingly over the base ring and can have a radially inward protruding locking edge.

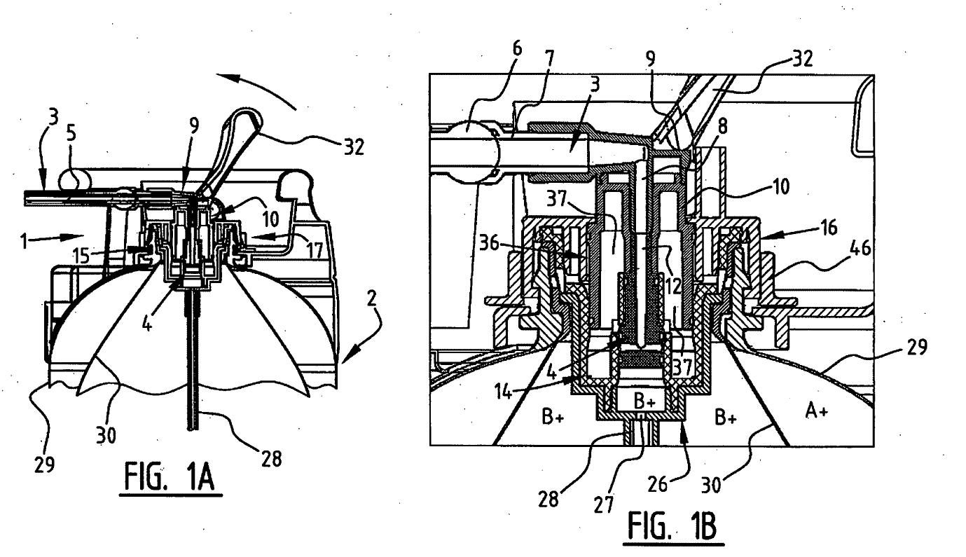

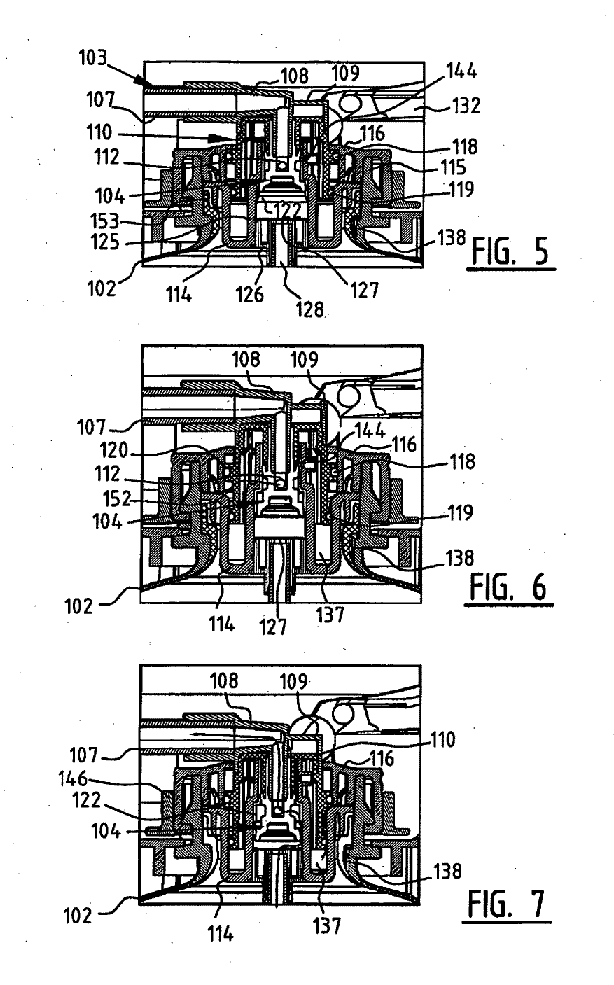

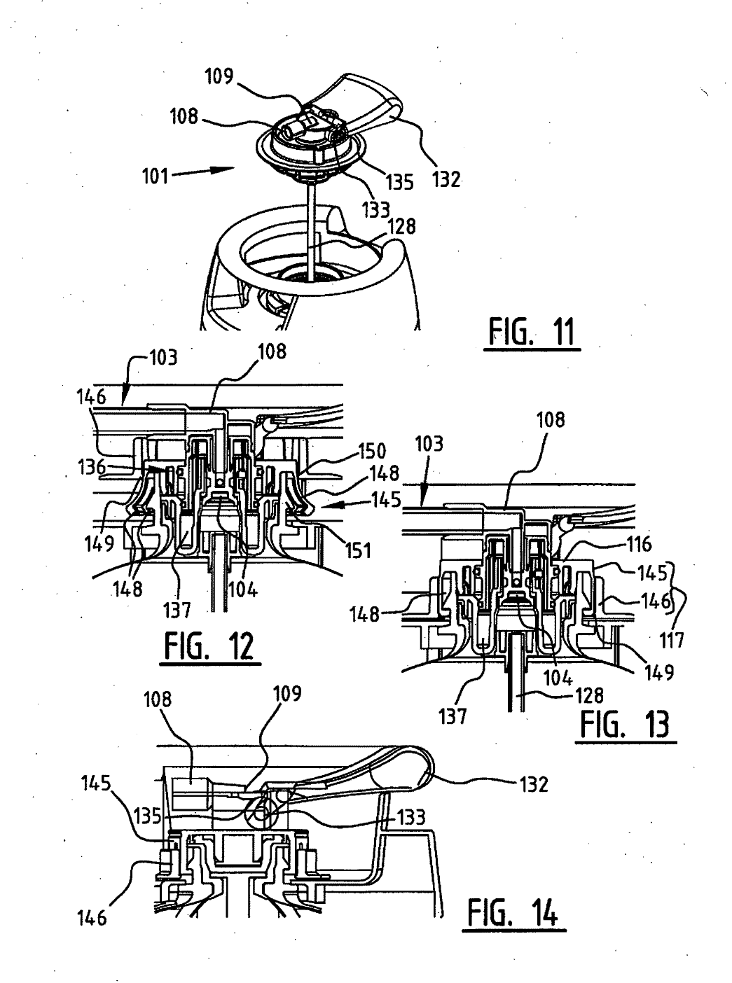

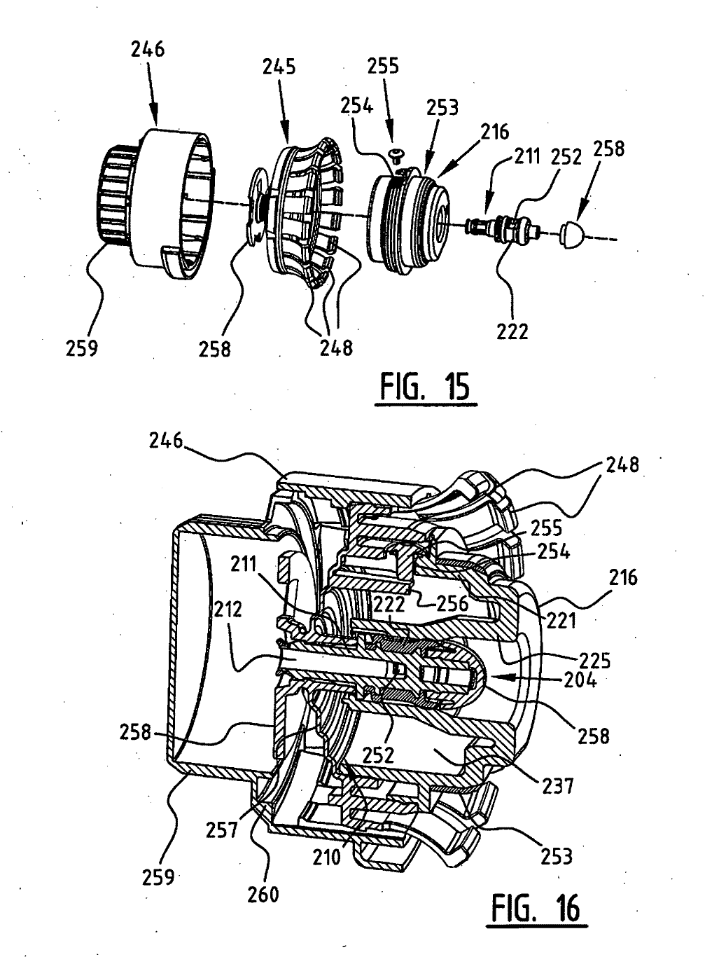

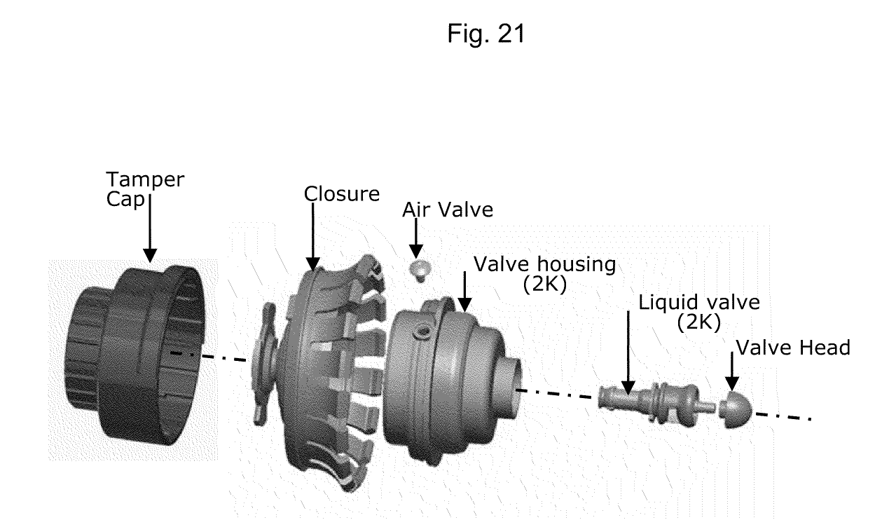

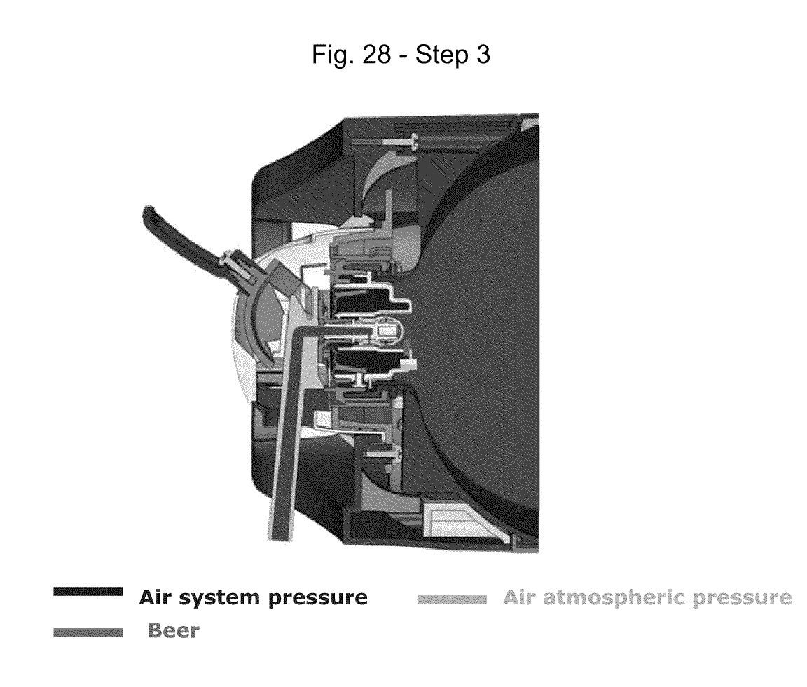

Various aspects of the invention will next be described with reference to three types of exemplary embodiments, wherein reference is made to the accompanying drawings. FIGS. 1-4 relate to one type of exemplary embodiments, FIGS. 5-14 relate to an alternate type of exemplary embodiments, and FIGS. 15-20 relate to a third type of exemplary embodiments (FIGS. 21-44 will be described following the discussion of FIGS. 1-20). It is noted that many of the structures and elements described with reference to each type of exemplary embodiments appear in many of the relevant figures to that embodiment. Where convenient, a particular figure is pointed to, but the reader will note that reference to a plurality of figures is often useful to follow the description.

As shown in FIGS. 1, an exemplary device 1 for dosed dispensing of a liquid B, such as, for example, beer, from a container 2 includes an outflow channel 3 which can be connected to holder 2 and which can, for example, be closed by a liquid valve 4. Outflow channel 3 can have, for example, an outlet part 5 which can be connected via ball joint 6 (FIG. 1B) to a horizontal part 7, which can in turn be clamped in a widened part of a pipe bend 8. This pipe bend 8 forms part of a button 9 which is snapped onto a staged, cylindrical gas valve 10, which in turn forms part of blow-out structure 36, detailed below.

The vertical part of pipe bend 8 can protrude into an inner casing 11 of gas valve 10, in which liquid valve 4 can also be mounted. Liquid valve 4 can likewise take a staged cylindrical form and can have a T-shaped channel 12 (FIG. 1B), one leg of which running axially through the narrow part of valve 4, and the other leg running transversely through the wide part of valve 4 and opening on either side in the periphery thereof.

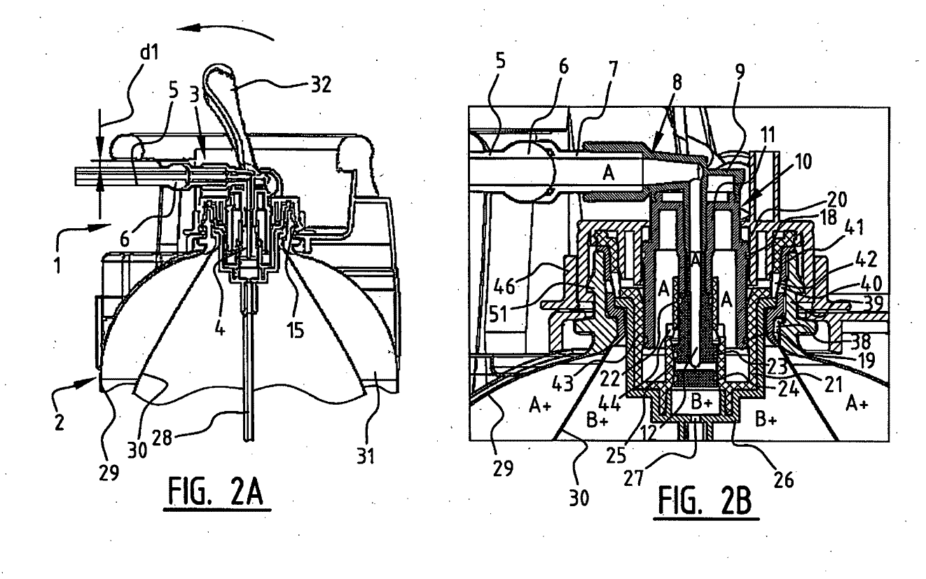

In exemplary embodiments of the present invention, liquid valve 4 and gas valve 10 can be received for jointly sliding in two-part housing 13, an inner part 14 of which can be, for example, suspended in a neck 15 of container 2, while an outer part 16 can, for example, be fixed onto neck 15 by means of connecting means 17, discussed below. In exemplary embodiments of the present invention gas valve 10 can have two sealing rings 18, 19 which can, for example, co-act with respectively (i) an inner casing 20 of upper housing part 16 and (ii) an outer casing 21 of lower housing part 14. In exemplary embodiments of the present invention liquid valve 4 can have three sealing rings 22, 23, 24 (FIG. 2B), which can co-act with different parts of staged inner casing 25 of inner housing part 14, for example.

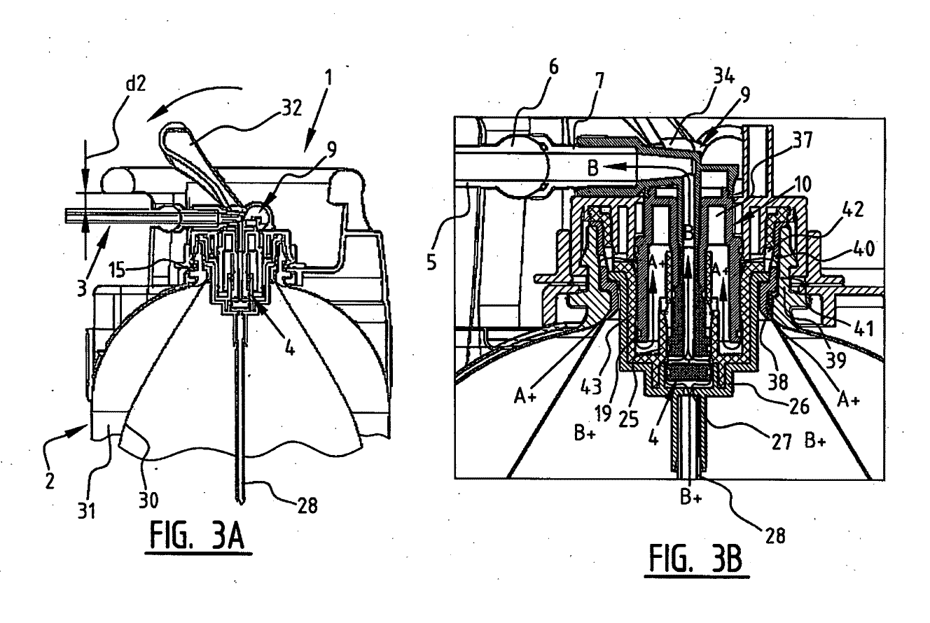

Again with reference to FIG. 1B, inner housing part 14 can be received in vessel 26, itself suspended in neck 15 of container 2. Vessel 26 can have an opening 27 on its underside, which can be connected to the interior of container 2. Attached to the underside of vessel 26 can be, for example, an immersion tube 28 (dip tube) with which liquid can be carried from the bottom of container 2 to dispensing device 1. Dispensing device 1 can be operated by means of a handle 32 mounted on the top side of upper housing part 16 for pivoting about a horizontal shaft 33. Handle 32 can have an engaging part 34 which presses button 9 when handle 32 pivots on shaft 33, as can be seen by the increasing distance d1, d2 between outflow channel 3 and the top of the device, as seen in FIGS. 2A and 3A. Handle 32 can otherwise also be provided with two arms 35 which engage under an edge of button 9 when handle 32 takes up its rest position. In exemplary embodiments of the present invention, button 9 is then thereby blocked against being pressed.

In exemplary embodiments of the present invention, container 2 can be, for example, assembled from a form-retaining outer container 29, which can be manufactured from a relatively stiff plastic, and a deformable inner container 30 in which the liquid B is received, as shown in FIGS. 1-2. In exemplary embodiments of the present invention inner container 30 can be connected, for example, adhered or welded, to outer container 29 at the position of neck 15. In addition, inner container 30 can, for example, also be connected to outer container 29 at another location, for instance at the position of the base, for which purpose a welded or adhesive connection, for example, is suitable. In exemplary embodiments of the present invention such a connection at two locations prevents inner container 30 from crumpling when pressure is exerted thereon so as to dispense liquid B out of container 2. Defined between inner container 30 and outer container 29 can be a space 31 in which a displacing gas A can be provided at a higher than atmospheric pressure (as indicated by the “+” sign in FIGS. 1-4). In the shown example the displacing gas A is air which is drawn in through an opening in the bottom of outer container 29 and pressurized by a pump (not shown). Such pressure can be, for example, approximately 1.5 bar.

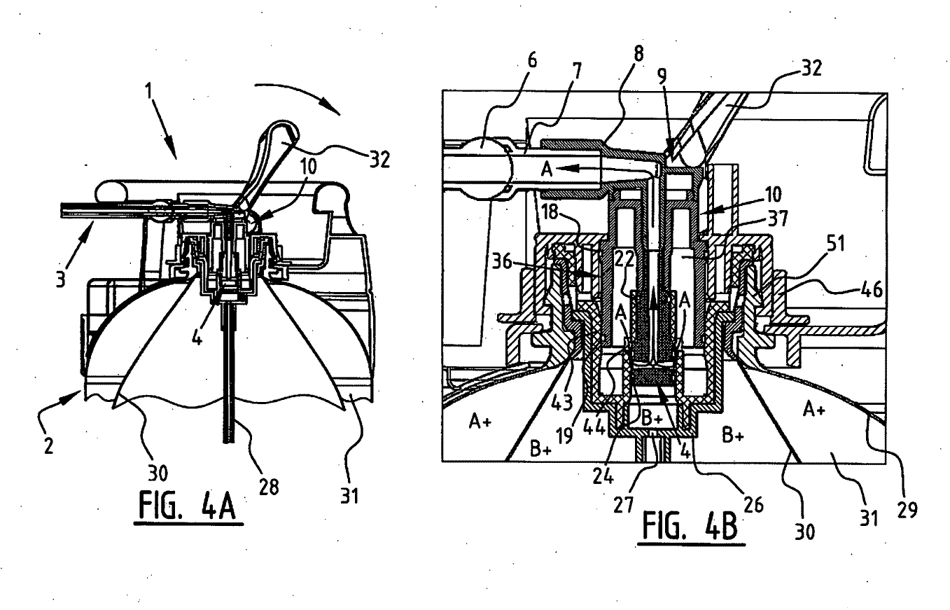

In exemplary embodiments of the present invention, dispensing device 1 can be provided with structure 36 for blowing out outflow channel 3 once liquid valve 4 has closed, after liquid B has been dispensed. Such blow-out structure 36 can operate, when liquid valve 4 is closed, to connect outflow channel 3 to a source of gas under a higher than atmospheric pressure, such as, for example, the displacing gas A provided in space 31. In the shown embodiment blow-out structure 36 can include an intermediate chamber 37 which can be bounded by gas valve 10 and inner housing part 14. This intermediate chamber 37 can be, for example, connected to space 31 when liquid valve 4 is opened (FIG. 3), and can be, for example, connected to outflow channel 3 when liquid valve 4 is closed (FIG. 4). In this way a limited amount of the displacing gas A is guided to outflow channel 3 (thus conserving it).

The connection between space 31 and intermediate chamber 37 can be formed by channel 38 (FIG. 3B) recessed into neck 39 of outer container 29, a space between neck 39 of outer container 29 and neck 41 of inner container 30, a number of openings 40 in neck 41, a number of openings 42 corresponding thereto in lower housing part 14, and a gap between lower and upper housing parts 14, 16 (FIG. 1B). Such connection can be left clear as soon as lower sealing ring 19 of gas valve 10 moves clear of a thickened portion 43 (FIG. 2B) of outer wall 21 of inner housing part 14, after which the intermediate chamber 37 fills with displacing gas A (at under a higher than atmospheric pressure). Together, lower sealing ring 19 and thickened wall portion 43 form a gas supply structure for gas valve 10.

With reference to FIG. 4B, the blow-out structure can further include a number of openings 44 in inner casing 25 of inner housing part 14 which open into a somewhat widened part of this casing and T-shaped channel 12. Together they can, for example, form the connection between intermediate chamber 37 and outflow channel 3. This connection is left clear as soon as the middle sealing ring 23 of liquid valve 4 reaches such widened portion of inner casing 25, sealing ring 23 and inner casing 25, effectively forming a discharge structure for gas valve 10. When this occurs, the separated quantity of displacing gas A can flow out of intermediate chamber 37 through outflow channel 3 to the outside, where a lower pressure prevails, i.e. atmospheric pressure. Any liquid residue possibly remaining in outflow channel 3 is thus also carried away with such gaseous discharge.

In accordance with a second aspect of the invention, displacing gas A can be introduced into outflow channel 3 at its upstream end, i.e., immediately downstream of liquid valve 4. In exemplary embodiments of the present invention, this can be achieved by causing displacing gas A to follow the same path through T-shaped channel 12 as liquid B.

According to a third aspect of the invention, liquid valve 4 can be biased towards its closed position by the higher than atmospheric pressure prevailing in container 2. It is thus possible to dispense with the use of resetting springs or similar provisions. The pressure on liquid B (indicated by a “+” sign in the various figures) in inner container 30, which is by definition the same as that of air A in space 31, acts on the wide part of the liquid valve, while the pressure of the air in intermediate chamber 37 acts only on the edge between the wide and narrower part of liquid valve 4, as shown in FIG. 3. The overall effect of this is that an upward directed force is exerted on liquid valve 4 which must be overcome during dispensing of the liquid by a user pressing on button 9 via handle 32. As soon as handle 32 is released, the pressure on the underside of liquid valve 4 will move it upwards to its closed position, where handle 32 pivots back to its starting position.

In similar fashion, gas valve 10 can be biased to its closed position by the higher than atmospheric pressure of the air in intermediate chamber 37, which acts on its top surface. Such pressure is counteracted by the atmospheric pressure on the outside, so that the biasing force is determined by the overpressure of displacing gas A and the exposed surface area of gas valve 10.

An alternate exemplary embodiment is next described with reference to FIGS. 5-14. In such alternative exemplary embodiment, liquid valve 104 (of dispensing device 101) can have a substantially X-shaped section (FIG. 5) with a relatively wide lower end which can be provided in a widened part of inner casing 125 of lower housing part 114, a somewhat narrower upper end and a constriction lying therebetween. Channel 112 in liquid valve 104 is here not T-shaped, but rather formed by a blind bore with a number of radial openings 152 in the wall of the constriction. In contrast to the first exemplary embodiment type, liquid valve 104 is not provided with any sealing rings. Inner casing 125 of inner housing part 114 is instead covered with a layer of relatively soft sealing material 122, which can be, for example, integrally formed with housing part 114 by a two-component injection molding process, for example. This sealing layer 122 and the upper end of the liquid valve body 104 again form a discharge structure for gas valve 110. Also formed in similar manner, along the outer periphery of inner housing part 114, can be, for example, a soft layer 153 which can seal against neck 141 of inner container 130. Inner housing part 114 is in this case not provided in a vessel. A small vessel 126, having thereon the immersion tube 128, can instead be clamped in inner casing 125 of housing part 114. Here again, blow-out structures 136 comprise gas valve 110, intermediate chamber 137 and radial openings 152.

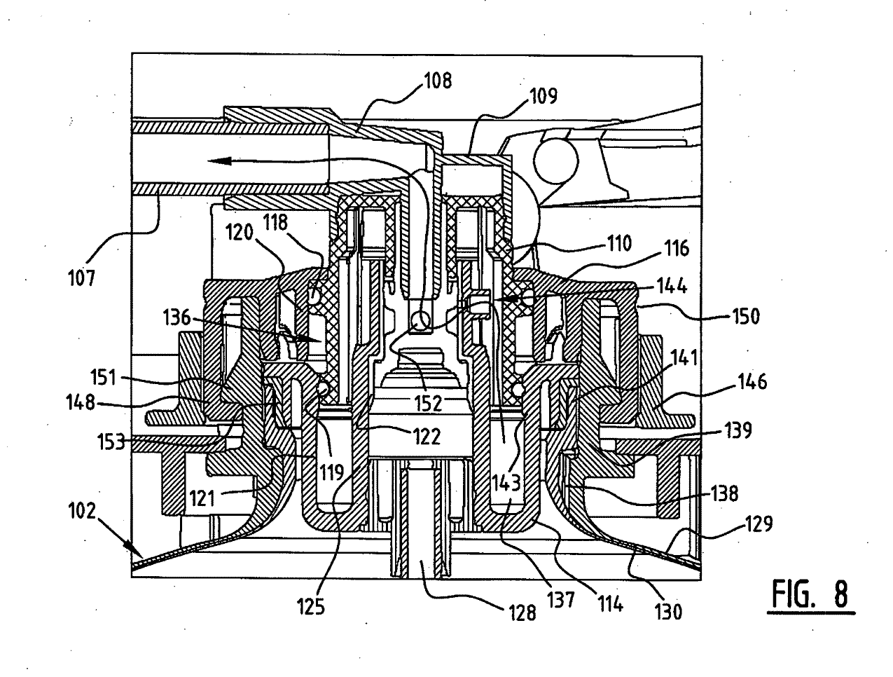

Space 131 between outer container 129 and inner container 130 can, for example, be connected to intermediate chamber 137 by a channel 138 in neck 139 of outer container 129, a space between necks 139 and 141 of outer container 129 and inner container 130, and a gap between the lower and upper housing parts 114, 116. In exemplary embodiments of the present invention the final part of the connection between space 131 and chamber 137 can be, for example, established when lower sealing ring 119 of gas valve 110 is moved downward past a thickened part 143 of outer casing 121 of lower housing part 114. This again opens the supply structure formed by the ring 119 and casing part 143 (FIG. 8).

The connection between intermediate chamber 137 and outflow channel 103 can be formed, for example, by an opening 144 in inner casing 125 of inner housing part 114, here opening into the relatively narrow upper part of this casing, the constriction in liquid valve 104, the radial opening 152 in this valve and blind bore 112. Opening 144 here can have a carefully dimensioned restriction, whereby the delivery of air A under higher than atmospheric pressure to outflow channel 103 can be precisely controlled with respect to flow rate and outflow time in order to achieve an optimum blow-out action. Since the air A follows the same path through the radial opening 152 as does liquid B, cleaning of outflow channel 103 starts at the very beginning of the channel. In this exemplary embodiment type gas valve 110 and liquid valve 104 are again also connected to each other such that gas valve 110 is closed when liquid valve 104 is opened in order to dispense liquid B from container 102 (FIG. 7), while gas valve 110 is opened as soon as liquid valve 104 is closed (FIG. 8). Liquid valve 104 can be, for example, here again biased to its closed position by liquid pressure acting on its relatively wide lower end, which is counteracted only by the pressure of the displacing air A acting on the outer flange of the relatively narrow upper end. In exemplary embodiments of the present invention, gas valve 110 can be biased to its closed position by the air at higher than atmospheric pressure in chamber 137 acting on its lower flange and its top surface.

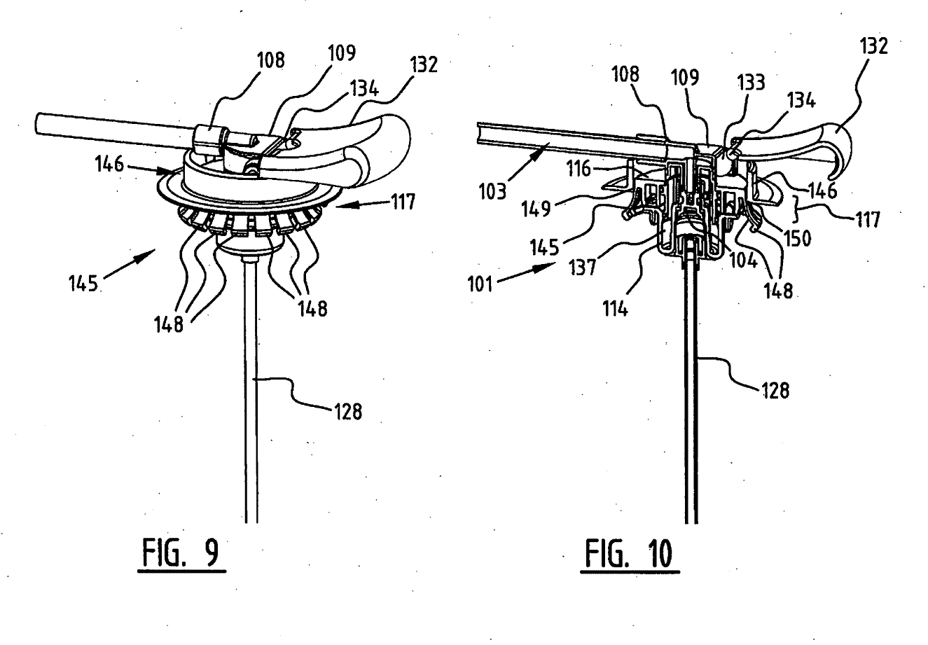

With reference to FIGS. 1-4 and to FIGS. 9-10, in exemplary embodiments of the present invention, dispensing device 1, 101 can be provided with a connector 17, 117 for connecting outflow channel 3, 103 to container 2, 102. In both the shown embodiments of FIGS. 1-4 and of FIGS. 5-14, such connectors 17, 117 can include a resilient ring 45, 145 arranged around neck 15, 115 of container 2, 102 and a locking ring 46, 146 which can, for example, be arranged around resilient ring 45, 145. In the shown examples resilient ring 45, 145 can be integrally formed with outer housing part 16, 116.

Resilient ring 45; 145 can include, for example, a non-deformable base part 47, 147 extending annularly around gas valve 10, 110, and a number of resiliently deformable, L-shaped hooking fingers 48, 148 extending outward in a radial direction from base ring 47, 147. Fingers 48, 148 can define (enclose) an acute angle with the longitudinal axis of immersion tube 28, 128 and channel 12, 112. Locking ring 46, 146, for example, can close-fittingly slide over base ring 47, 147 and can have, for example, a locking edge 49, 149 protruding radially inward. Such locking edge 49, 149 can engage in a peripheral groove 50, 150 of base ring 45, 145 when locking ring 46, 146 occupies its uppermost non-tensioned position (FIGS. 9, 10, 12). When locking ring 46, 146 is pushed downward over resilient ring 45, 145, hooking fingers 48, 148 are forced inward, where they can engage under a protruding edge 51, 151 of neck 15, 115 and thus fix upper housing part 16, 116 firmly onto container 2, 102. In the lower position of locking ring 46, 146 its locking edge 49, 149 then engages, for example, under a rounded or chamfered part of each hooking finger 48, 148 at the position of the angle of the L-shape of such hooking finger. This can insure, for example, that dispensing device 1, 101 cannot become unintentionally detached from container 2, 102, even when high pressures occur therein.

Yet other exemplary embodiments of the invention are depicted in FIGS. 15-20. In such exemplary embodiments, blow-out structures can, for example, include intermediate chamber 237, defined by lower housing part 214 and upper housing part 216, and gas valve 210. Gas valve 210 can again include, for example, separate structures for supplying pressurized gas from space 231 to chamber 237, and for discharging pressurized gas from chamber 237 into outflow channel 203. In such exemplary embodiments a gas supply structure can include an opening 254 in outer casing 221 of lower housing part 214, which can be, for example, closed off by an umbrella-shaped valve member 225. Valve member 255 can be operated by an arm 256 protruding from the top surface 257 of upper housing part 216.

Top surface 257 can be formed by a stepped diaphragm, which can be, for example, resiliently flexible. It can carry, for example, a tubular valve member 211 defining a blind bore channel 212 and can be provided with a radial opening 252. A lower part of tubular valve member 211 can be covered by an integrally molded contoured layer of sealing material 222, which can sealingly engage inner casing 225 of lower housing part 214. A bulbous streamline body 258 can, for example, be pressed onto a lower end of tubular valve member 211 extending into a widened part of inner casing 225, which can open towards container 202. Thus, no immersion tube is used in such exemplary embodiments.

The illustrated variant of this embodiment is intended for use with a container 202 that is to be mounted in a dispensing installation. To this end a bayonet member 258 extends from top surface 257 of upper housing part 216, which can, again, be integrally made with resilient ring 245, for connection to a dispensing installation. Such a dispensing installation can include outflow channel 203 and pivoting handle 232. Before mounting of container 202 in the dispensing installation, valves 204, 210 can be protected against inadvertent operation by a cap 259 connected to locking ring 246 by anti-tamper strips 260. It is noted that the principles of this embodiment, in particular the shape and arrangement of valves 204, 210 and chamber 237 can also, for example, be applied to a container mounted dispensing device having its own outflow channel and operating handle.

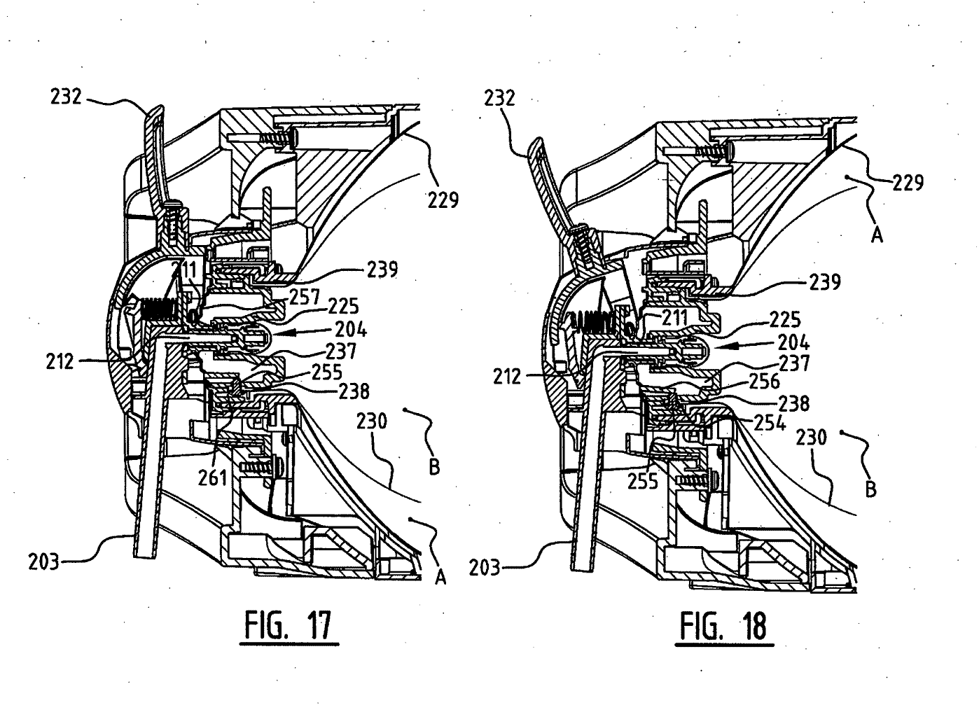

In such exemplary embodiments, the connection between space 231, containing the displacing air under higher than atmospheric pressure, and intermediate chamber 237, can be formed by a channel 238 in neck 239 of outer container 229, and a space 261 between outer container neck 239 and lower housing part 214. Space 261 can communicate with intermediate chamber 237 through opening 254, when valve member 255 is lifted from its seat by movable arm 256, as shown for example in FIG. 18. This happens when operating handle 232 is pivoted from its rest position (FIG. 17) to its intermediate position, pushing down the diaphragm-shaped top surface 257 of upper housing part 214. This same movement causes tubular valve member 211 to slide downward through inner casing 225 of lower housing part 216. This will bring sealing layer 222, surrounding radial opening 252, in sealing engagement with a narrowed part of the inner casing 225, thus closing opening 252 and disconnecting intermediate chamber 237 from outflow channel 203.

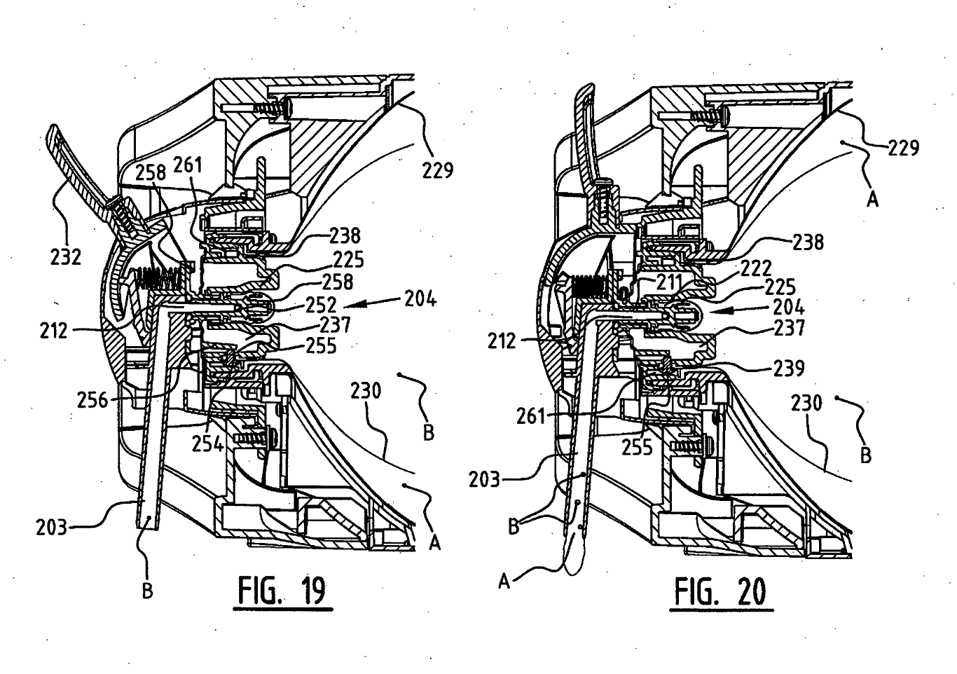

In exemplary embodiments of the present invention, after intermediate chamber 237 has been filled with displacing gas A, further pivoting of handle 232 and further downward movement of top surface 257 and tubular valve member 211 will cause a constriction in contoured sealing layer 222 within a widened part of inner casing 225. This will allow liquid B, which, as noted, is under a pressure greater than atmospheric pressure, to flow from inner container 230 through radial opening 252 and channel 212 of liquid valve 204 into outflow channel 203 as shown in FIG. 19.

Thus, when handle 232 is released, the pressure of liquid B in inner container 230 acting on liquid valve 204, in combination with the pressure of displacing air A in chamber 237 acting on the top surface 257 of gas valve 210, will cooperate to force the top surface 257 up and close both liquid valve 204 and air supply valve 255. The upward movement of tubular valve member 211 will bring the constriction in contoured sealing layer 222 surrounding opening 252 in an upper, slightly widened part of inner casing 225. This will allow the displacing air A in chamber 237 to escape to the atmosphere through opening 252 and outflow channel 203, thus blowing any remaining drops or residue of liquid B out of the outflow channel 203, as shown in FIG. 20.

Due to the very compact design of the valves 204, 210 in this exemplary embodiment, intermediate chamber 237 can have a larger effective volume than in the previous embodiments described. Thus, a relatively high biasing force and a relatively powerful cleaning air jet can be generated, even at lower air pressures than in the other embodiments. This latter embodiment could well function at a pressure of 1 bar, rather than 1.5 bar.

### Exemplary Second Generation Non-dripping Nozzle and Device

Next described, with reference to color FIGS. 21-44 is an exemplary second generation non-dripping nozzle according to another exemplary embodiment of the present invention. Such second generation device is similar to the exemplary embodiments of FIGS. 15-20.

FIG. 21 depicts an exploded view of various components of a second generation non-dripping nozzle according to an exemplary embodiment of the present invention. These basic valve components are the same as those shown in FIG. 15.

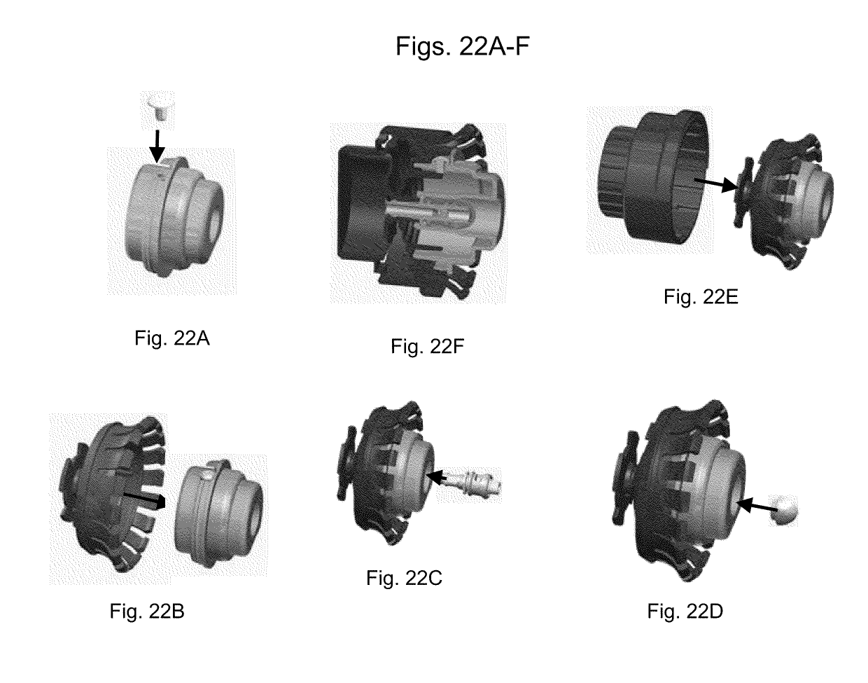

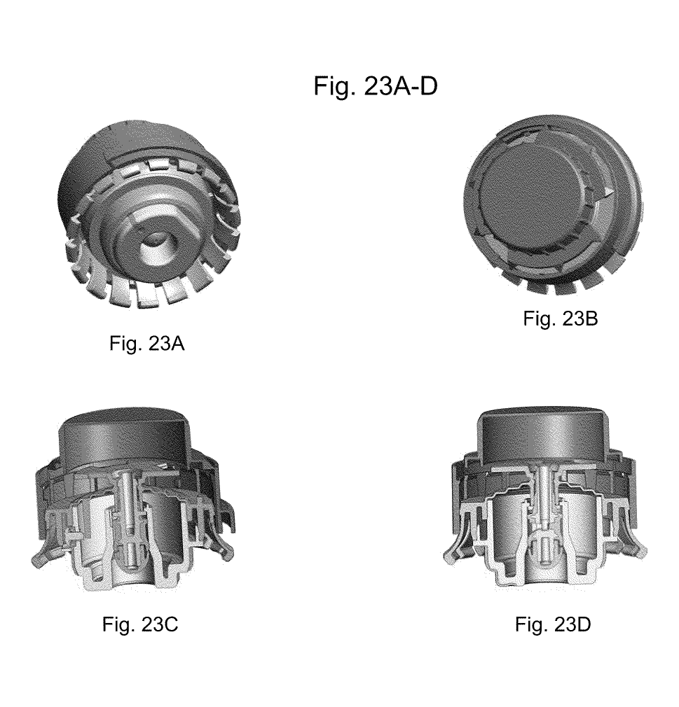

FIG. 22 depicts exemplary assembly of the second generation non-dripping nozzle according to an exemplary embodiment of the present invention. As can be seen therein, first the air valve is inserted, then the closure is placed upon the valve housing, then the liquid valve is inserted and the valve head affixed, and finally the tamper cap is placed over the assembled valve. The upper center pane of FIG. 22 depicts a cross sectional view of the fully assembled valve. FIG. 23 depicts two perspective and two cross sectional views of the assembled non-dripping nozzle of FIGS. 21 and 22.

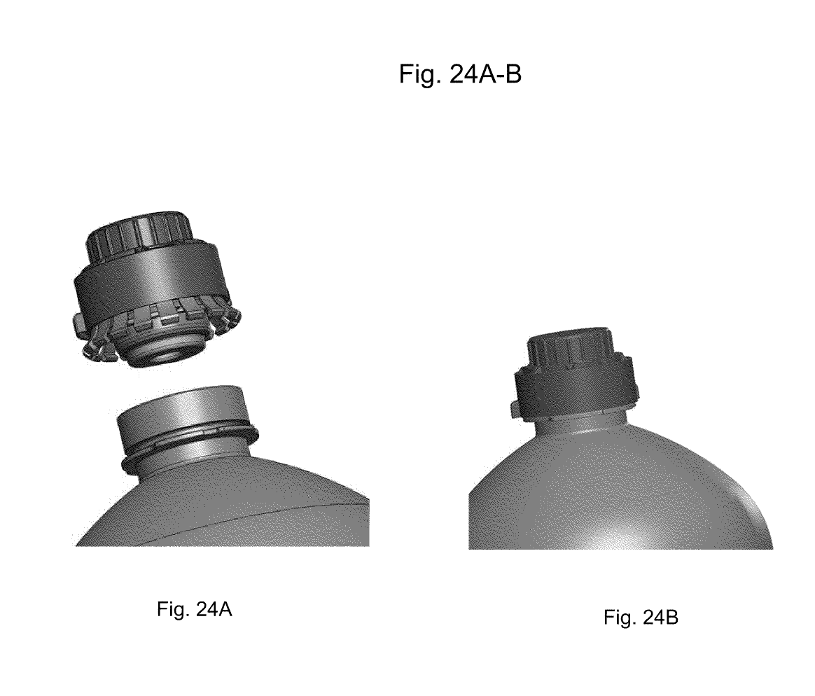

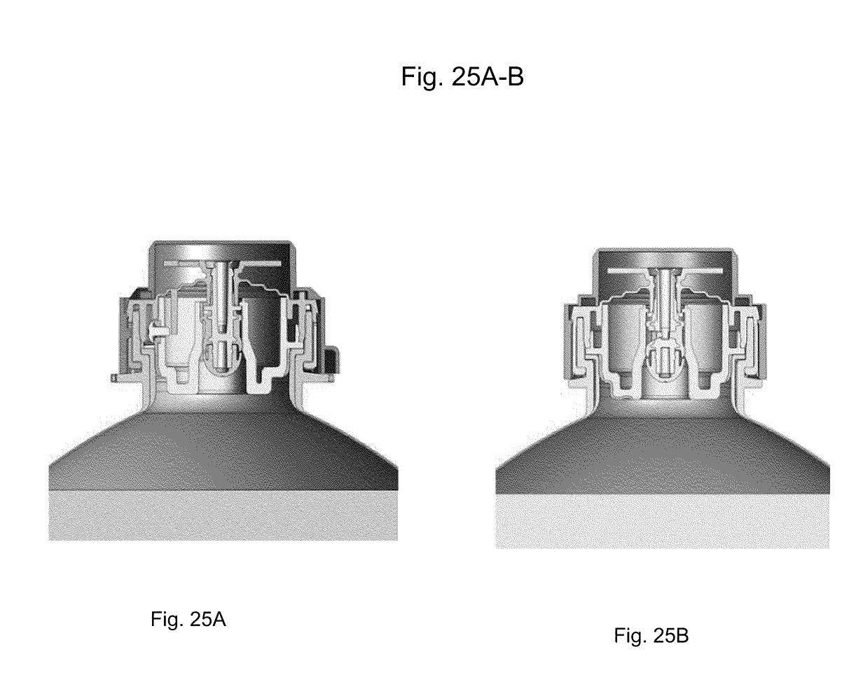

FIG. 24 depicts the exemplary non-dripping nozzle valve off and as attached to an exemplary bottle according to an exemplary embodiment of the present invention, and FIG. 25 depicts two cross-sectional views of the assembled non-dripping nozzle as attached to an exemplary container. The cross sections are taken along substantially the same planes as those shown in the bottom two panes of FIG. 23, and are essentially respectively the same, with the exception that here in FIG. 25, of course, the valve is shown as attached to an exemplary container.

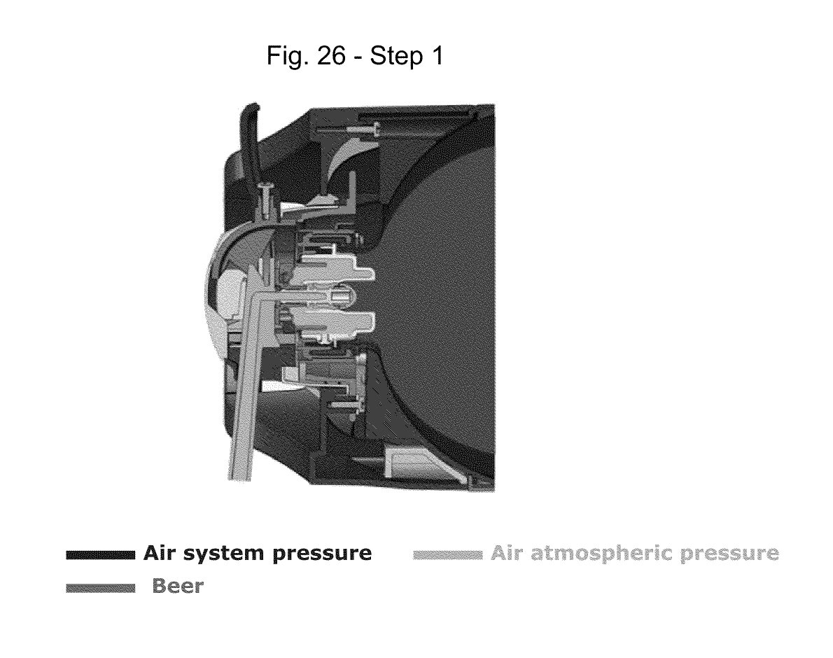

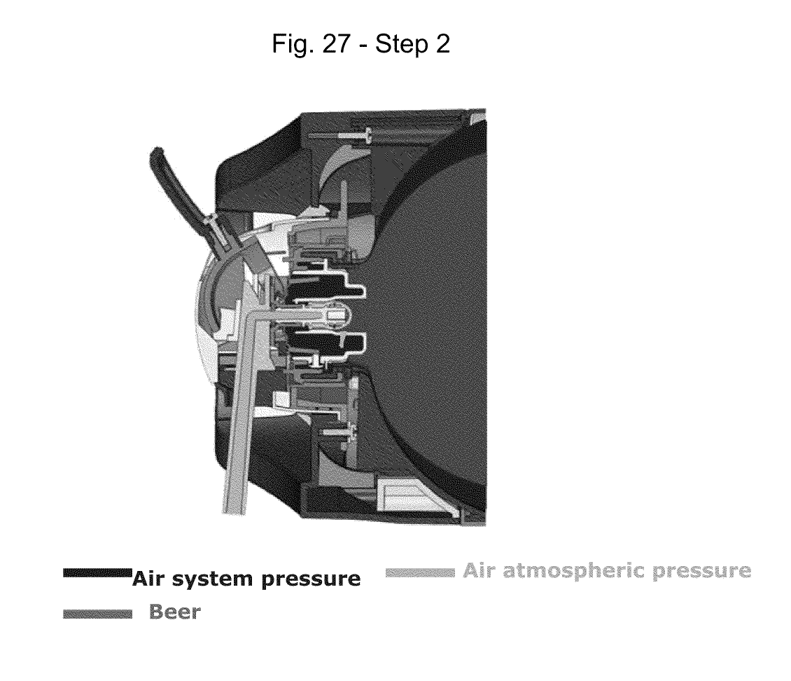

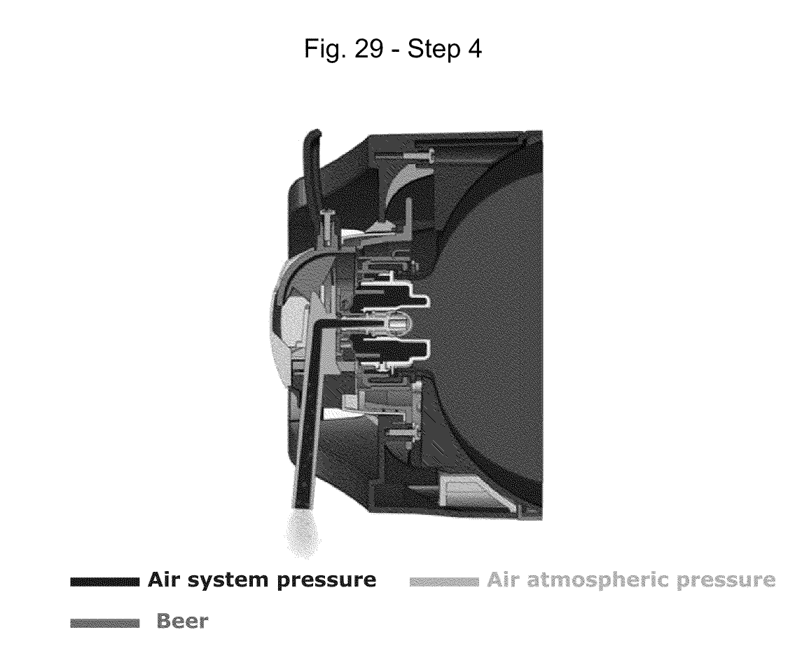

FIGS. 26-29 depict various steps in dispensing a liquid according to exemplary embodiment of the present invention. FIG. 26 shows the system ready for use, where atmospheric pressure prevails in the outflow channel and in the intermediate chamber (light blue) and the higher than atmospheric pressure system pressure prevails in the space between the inner container and the outer container (dark blue). The liquid to be dispensed, for example beer, has been filled in the inner container, and is shown in pink. The valve is in its resting position. In FIG. 27, the red handle has been moved somewhat downward, to an intermediate position. Here both the air and the liquid (beer) lines are closed, but the movement of the handle has caused the valve to allow high pressure air (dark blue) to enter the intermediate chamber from the displacement chamber between the inner and outer containers. Because the air line to outflow channel is still closed, the outflow channel still has atmospheric pressure in it, and there is neither liquid nor high pressure air exiting through it. FIG. 29 shows the next step in a dispensing sequence, where the red handle is now fully pulled downwards, and thus causing the valve to open the liquid to outflow channel passage. Pink beer flows from the inner container through the outflow channel, to be dispensed to a thirsty user.

Finally, in FIG. 29, the final step is depicted. The user lets go of the red handle, causing the valve to close off the liquid line. However, the high pressure air in the intermediate chamber is now allowed to vent out, blowing out the outflow channel, and cleaning it, as described above. Once the high pressure air has escaped, the device returns to the situation of FIG. 26, and because the valve is in its full resting position, there is no path from the displacement chamber to the intermediate chamber, the intermediate chamber will once again drop to atmospheric pressure.

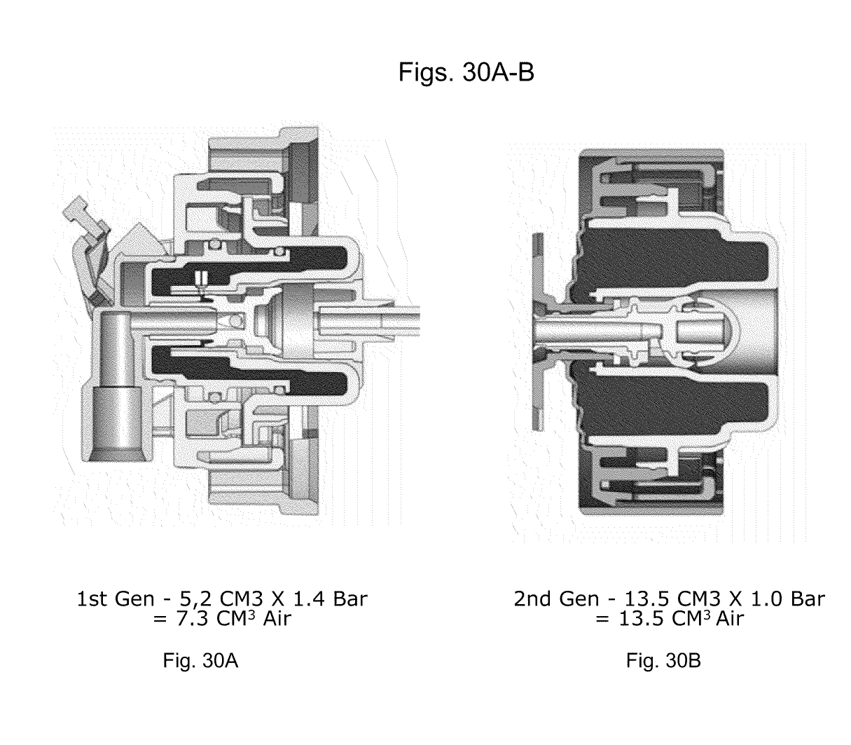

FIG. 30 depicts a comparison of blowout air volume in a first generation and a second generation device according to exemplary embodiments of the present invention. As can be seen, the advances in the second generation device nearly triple the intermediate chamber volume. Thus, operating even at a lower pressure, such as 1.0 versus 1.4 Bar, still the air volume available to blow out the nozzle is nearly doubled, 13.5 vs. 7.3 cm³.

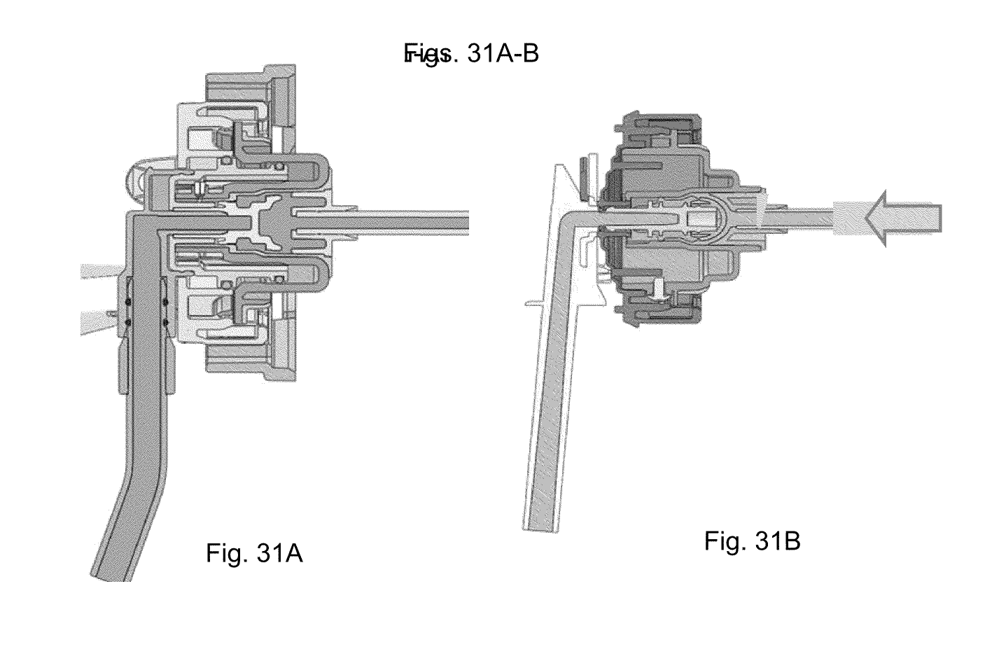

FIG. 31 depicts a cross sectional structural comparison of such first and second generation devices in a pouring step, showing, for example, that the second generation device has (i) fewer parts, (ii) less weight, (iii) more clearing air volume, (iv) smoother (liquid) beer flow, (v) only one liquid inlet in the liquid valve, (vi) better flow control, and (vii) easier assembly for the consumer.

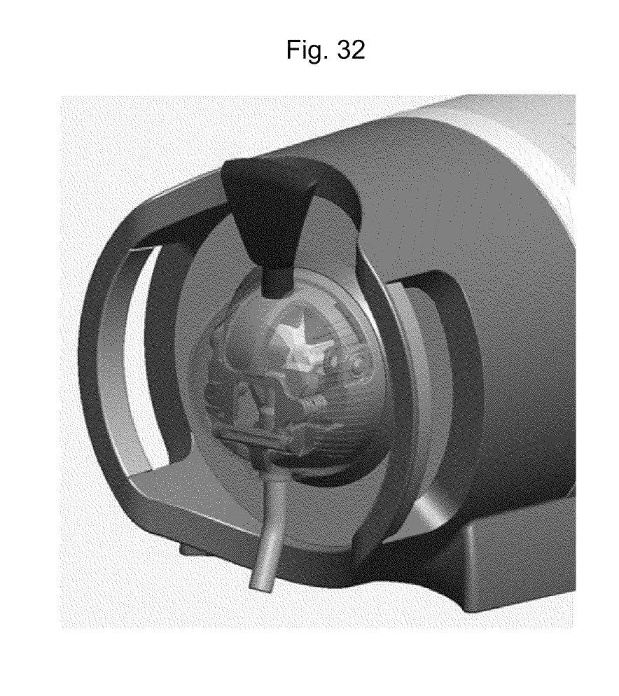

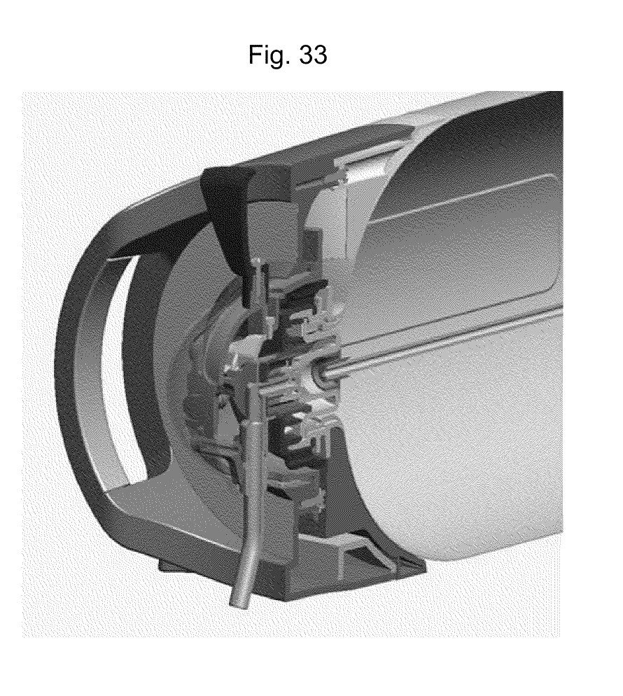

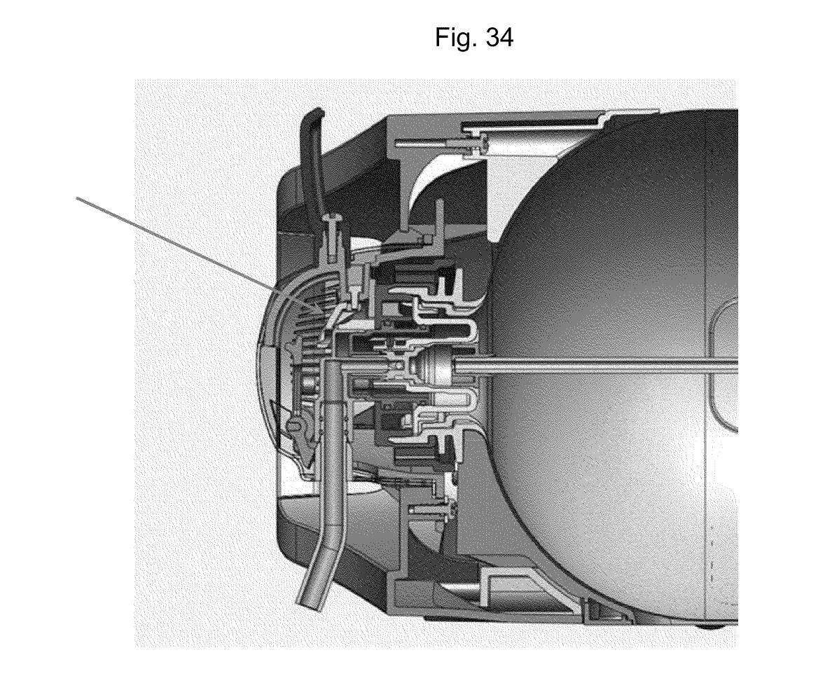

FIGS. 32-33 respectively depict a front view and a perspective cross-sectional view of the exemplary first-generation device of FIGS. 30-31 (left panes). Here the color coding of parts shown is as follows: the tap handle (red and green) is connected to the yellow part of the valve, which yellow part is pushing on the spout connector (blue). In the spout connector is a channel and the spout is connected to the spout connector. FIG. 34 depicts a longitudinal cross-sectional view of this exemplary first-generation device, again showing how the yellow part is pushing on the blue spout connector.

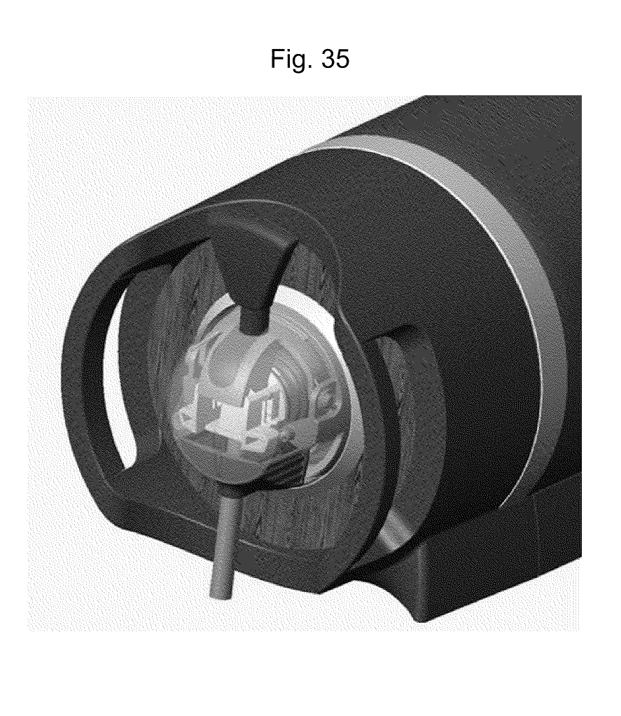

FIG. 35 depicts a front view of an exemplary second generation dispensing system, built to incorporate the exemplary second generation valve device of FIGS. 30-31 (right pane). This exemplary dispensing system has a tap handle connected to a valve pusher, which operates to change the state of the valve, as next described. Here the color coding of parts shown is as follows: the tap handle (red and green) is connected to the valve pusher (light pastel blue or aqua). It is in this part that the spout (orange) is assembled. Thus, the handle, valve pusher and spout are integrated in the Draught Flair system (actually part of the non-disposable appliance), and need not be provided in the valve (which is affixed to a disposable bottle, and thus a consumable).

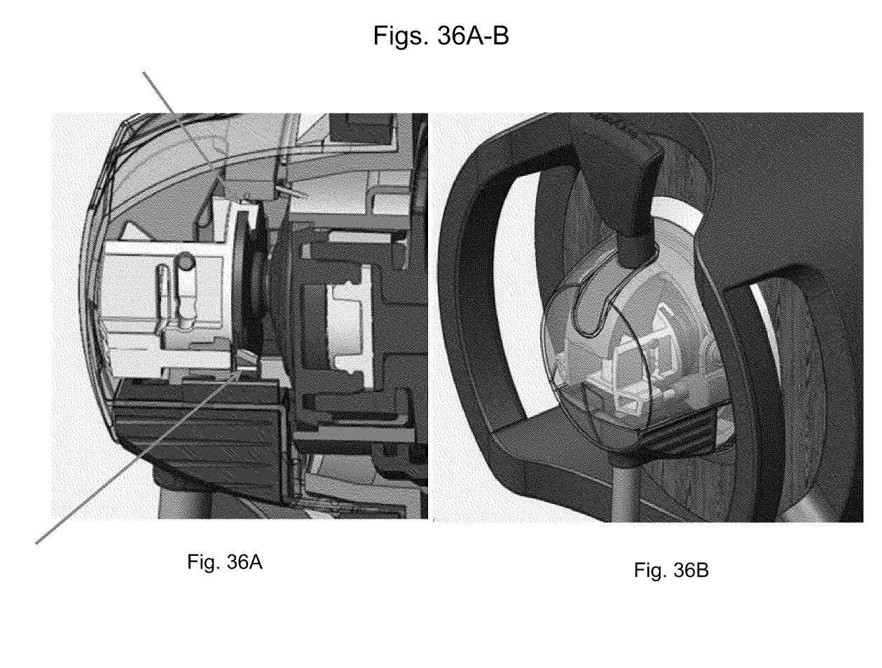

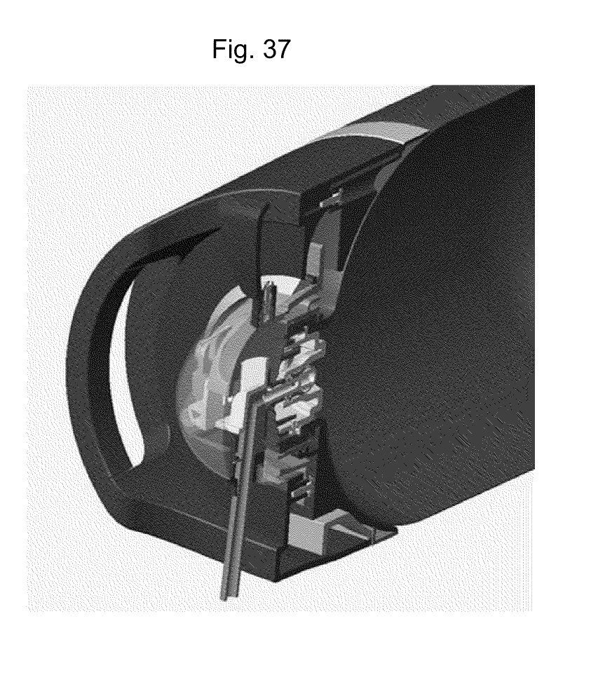

FIGS. 36-44 respectively depict various views and other additional details of the exemplary second generation device. An exemplary container with valve is installed in an appliance (containing the handle and valve pusher). FIG. 36 depicts how the valve pusher (light pastel blue or aqua part) can hook into the closure (red part) of the valve with bayonet hooks, for example, and FIG. 37 illustrates how the orange colored spout lies between the valve pusher (light pastel blue) and the closure (red).

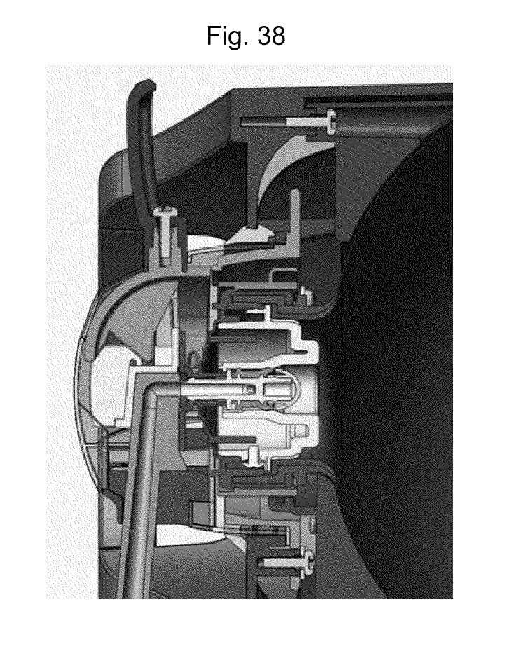

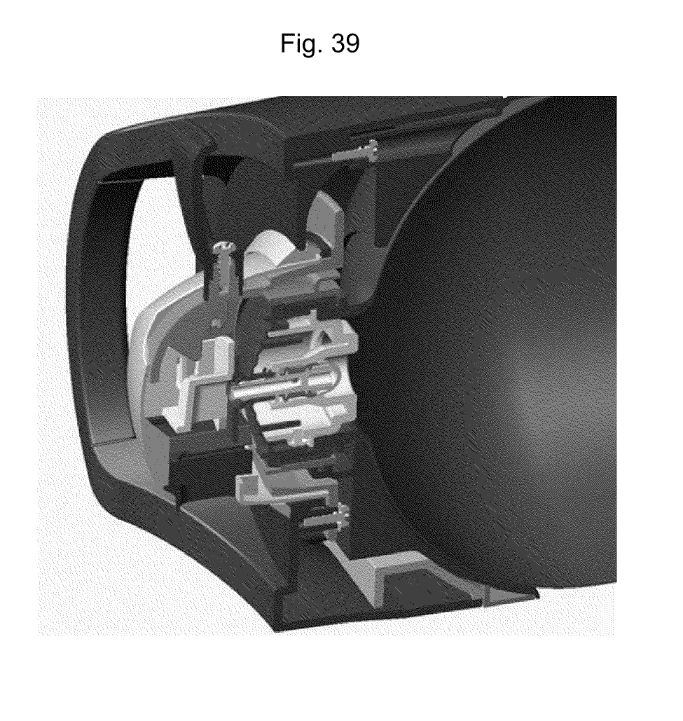

FIG. 38 shows how when the bottle with valve is placed in the system, the spout (orange), part of the appliance, is now directly connected to the channel of the liquid valve (light or “soft” green). During dispensing, the light pastel blue valve pusher pushes against the valve closure (red part) and the liquid valve (light or “soft” green part); all parts are moving into the direction of the bottle (to the right in FIG. 38) and thus the valve opens.

In this second generation configuration, there is no intermediate part between valve and spout; rather, the spout is directly connected to the channel of the liquid valve. The intermediate parts used in this exemplary system do not have a liquid channel.

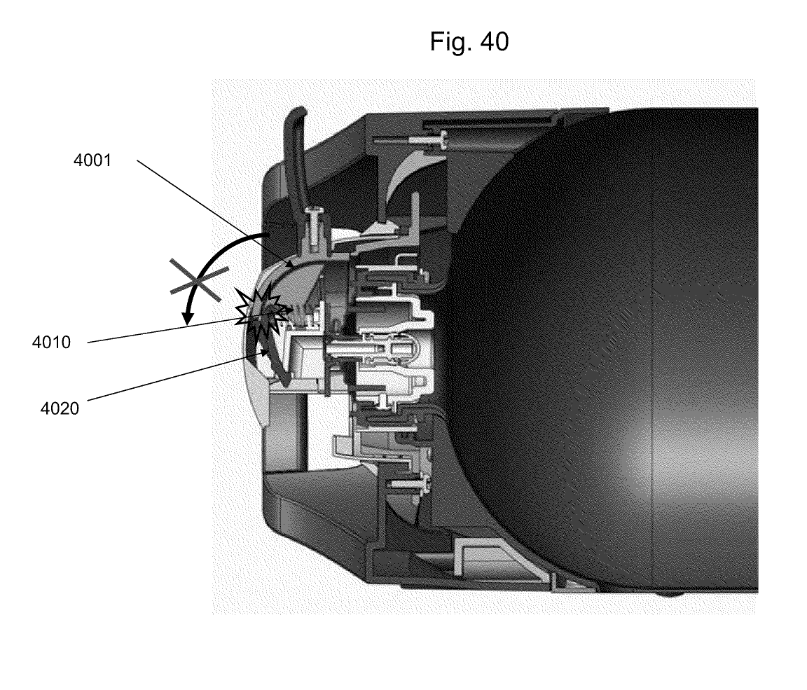

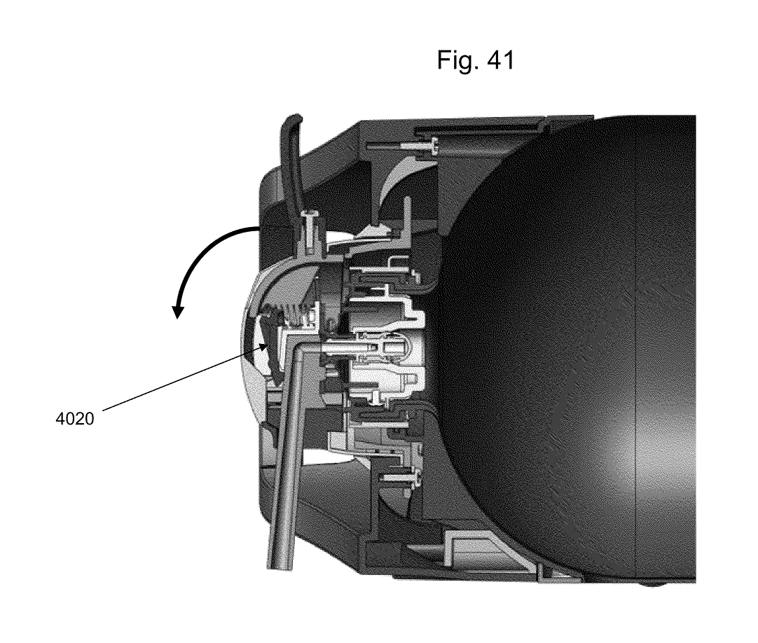

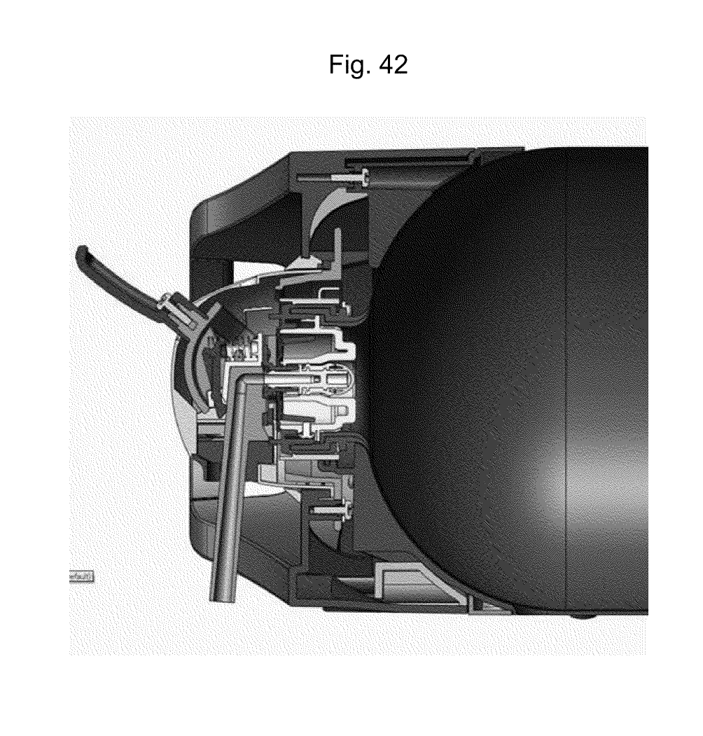

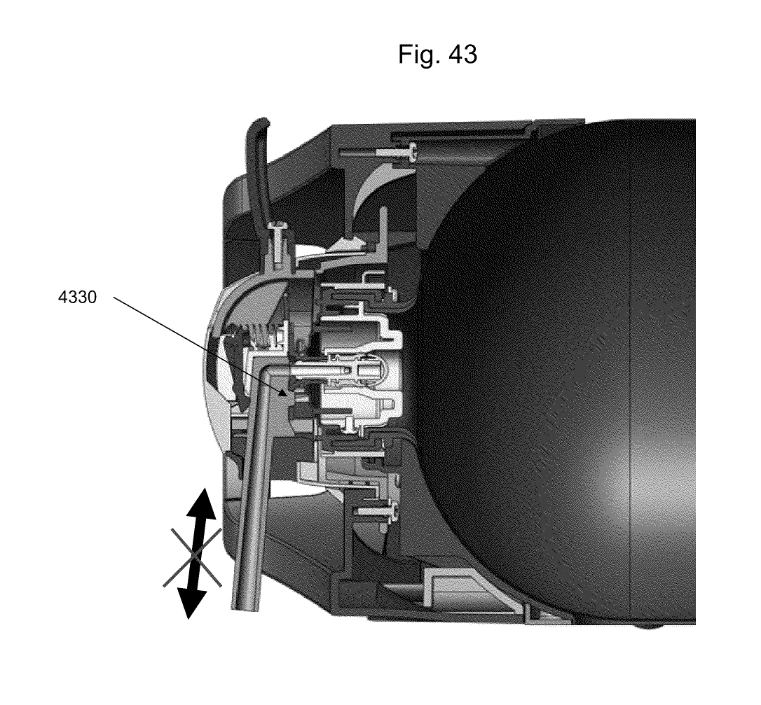

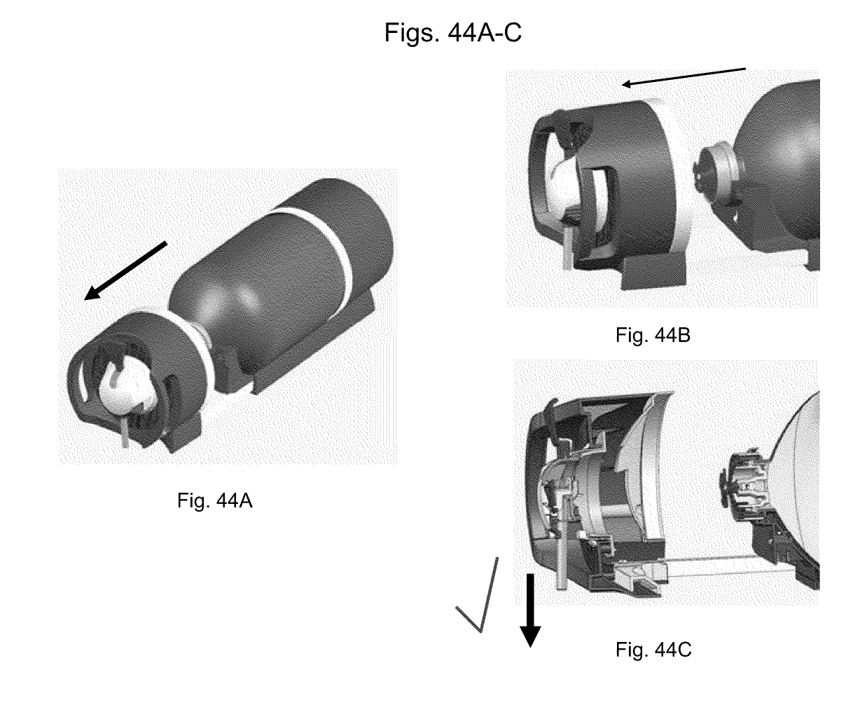

FIG. 39 shows how when the spout is not attached or assembled, the valve pusher (light pastel blue part) needs to be blocked, so a user cannot dispense without the spout (by pushing on the valve pusher via the tap handle). Thus, when there is no spout installed, the tap handle can be blocked by a tap handle-lock and spring, as shown in FIG. 40. Then, as shown in FIG. 41, when the spout is installed, the tap handle lock can be rotated, releasing the tap handle for normal use. Thus, as shown in FIG. 42, in a dispensing position of this second generation device, there is no interference or obstruction between the tap handle and the tap handle-lock. However, to insure that the spout is not removed, in FIG. 43 is depicted the spout lock, which shows how the spout, once connected to container and valve, cannot be removed.

Finally, once a user depletes the container, and thus no beer is left to dispense, FIG. 44 shows how to remove the spout. When the grip top is opened, the spout can be taken out, as it is no longer locked by the container. Here can also be seen the various parts of the system that are part of the (non-disposable) appliance, and those—see valve at forward tip of container—that are part of the container and thus disposable.

Although the invention has been elucidated above on the basis of various exemplary embodiments and examples, it will be apparent that it is not limited thereto, but can be varied in many ways within the scope of the following claims.

What is claimed:

1. A method for dosed dispensing of a liquid from a container which is connected to an outflow channel closable by a liquid valve, comprising:
opening the liquid valve;
dispensing a measure of liquid from the container through the outflow channel and closing the liquid valve; and
blowing out the outflow channel after closing the liquid valve.

2. Method as claimed in claim 1, wherein during or after closing of the liquid valve the outflow channel is connected to a source of a gas under higher than atmospheric pressure.

3. Method as claimed in claim 2, wherein during dispensing the liquid is forced out of the container by a displacing gas under higher than atmospheric pressure, and a limited quantity of the displacing gas is guided to the outflow channel during or after closing of the liquid valve.

4. Method as claimed in claim 3, wherein during dispensing of the liquid the amount of displacing gas is guided into an intermediate chamber which is connected to the outflow channel during or after closing of the liquid valve.

5. Method as claimed in claim 1, wherein after closing the liquid valve the outflow channel is aerated from an opening located substantially immediately downstream of the liquid valve.

6. Method as claimed in claim 1, wherein at least during dispensing of the liquid a higher than atmospheric pressure prevails in the container and the liquid valve is biased to its closed position by this higher than atmospheric pressure in the container.

7. Method as claimed in claim 6, wherein the liquid valve is biased to its closed position by the liquid in the container.

8. Method as claimed in claim 3, wherein the liquid valve is biased to its closed position by the displacing medium in the container.

9. A device for dosed dispensing of a liquid from a container, comprising:
an outflow channel connectable to the container and closable by a liquid valve; and a blowing out structure for blowing out the outflow channel when the liquid valve is closed.

10. Device as claimed in claim 9, wherein the blow-out means are adapted to connect the outflow channel, when the liquid valve is closed, to a source of a gas under higher than atmospheric pressure.

11. Device as claimed in claim 10, wherein the container contains a displacing gas under higher than atmospheric pressure for the purpose of urging the liquid out of the container, and the blow-out means are adapted to guide a limited amount of the displacing gas to the outflow channel when the liquid valve is closed.

12. Device as claimed in claim 11, wherein the container is assembled from a form-retaining outer container and a deformable inner container in which the liquid is received, wherein the displacing gas is received in a space defined between the outer container and the inner container.

13. Device as claimed in claim 12, wherein the blow-out means comprise an intermediate chamber which is connected to the space between the inner and outer container when the liquid valve is opened, and which is connected to the outflow channel when the liquid valve is closed.

14. Device as claimed in claim 13, wherein the intermediate chamber is closable by a gas valve movable with the liquid valve.

15. Device as claimed in claim 11, wherein an opening formed in the outflow channel substantially immediately downstream of the liquid valve for aerating the outflow channel when the liquid valve is closed.

16. Device as claimed in claim 9, wherein at least during dispensing of the liquid a higher than atmospheric pressure prevails in the container and the liquid valve is biased to its closed position by said higher than atmospheric pressure in the container.

17. Device as claimed in claim 16, wherein the liquid valve is biased to its closed position by the liquid in the container.

18. Device as claimed in claim 11, wherein the liquid valve is biased to its closed position by the displacing gas in the container.

19. Device as claimed in claim 18, wherein the gas valve is biased to its closed position by the displacing gas.

20. Device as claimed in claim 9, wherein characterized by means for connecting the outflow channel to the container, which connecting means comprise at least one resilient ring to be arranged around an outflow opening of the container and at least one locking ring to be arranged around the resilient ring.

21. Device as claimed in claim 9, wherein the resilient ring comprises a substantially non-deformable base ring and a number of resiliently deformable hooking fingers protruding radially outward from the base ring, and the locking ring can slide close-fittingly over the base ring and has a radially inward protruding locking edge.
